(19) United States
(12) Patent Application Publication
(10) Pub. No.: US 2018/0088037 A1
(43) Pub. Date: Mar. 29, 2018

(54) REAL-TIME DOUBLE-BEAM IN SITU INFRARED SPECTRUM SYSTEM AND METHOD THEREOF

(71) Applicant: DALIAN UNIVERSITY OF TECHNOLOGY, Dalian City (CN)

(72) Inventors: Jiaxu LIU, DALIAN CITY (CN); Qin XIN, DALIAN CITY (CN); Cuilan MIAO, DALIAN CITY (CN); Jilei WANG, DALIAN CITY (CN); Jie XU, DALIAN CITY (CN); Hong MIAO, DALIAN CITY (CN); Hongchen GUO, DALIAN CITY (CN)

(21) Appl. No.: 15/711,718

(22) Filed: Sep. 21, 2017

(30) Foreign Application Priority Data
Sep. 24, 2016 (CN) 201610846387.1

(51) Int. Cl. G01N 21/35; G01N 21/01

(52) U.S. Cl. CPC G01N 21/35; G01N 21/01

(57) ABSTRACT

A real-time double-beam in situ infrared spectrum system and a method thereof. The system comprises two identical infrared spectrometers and a double-beam infrared reactor cell, wherein the double-beam infrared reactor cell is formed by connecting a sample cell and a reference cell which are identical, the sample cell and the reference cell are at the same level and respectively correspond to a sample spectrometer and a reference spectrometer, the two infrared spectrometers are synchronously controlled by computers, to synchronously collect spectrograms of sample beams and background beams in real time, so as to obtain real information about a species on the catalyst surface changing with the reaction time, and eliminate gas molecule vibration spectrum interference in a real-time state and transmission spectrum interference generated under a heating condition. The present invention makes a characterization result become more accurate and reliable, so that real-time information about an active center of the catalyst surface, an active phase and an intermediate species at different temperatures may be obtained under a changeable gas phase component condition.

### TECHNICAL FIELD

The present invention relates to a real-time double-beam in situ infrared spectrum system and a method thereof, which belongs to the technical field of spectrum analysis instruments.

### BACKGROUND

An infrared spectrometer is an instrument for analyzing the molecular structure and chemical composition using absorption characteristics of material to infrared radiation light with different wavelengths. The infrared spectrometer mainly comprises a light source, a monochromator, a detector and a computer processing information system. With the increase of application requirements, a series of changes have been made in an optical splitting system, which experiences prism, raster and interferometer successively, and a corresponding infrared spectrometer experiences prism spectrometer, raster infrared spectrometer and Fourier transform infrared spectrometer finally.

In situ Fourier transform infrared (in situ FT-IR), in situ diffuse reflectance infrared (in situ DRIFT) and attenuated total reflection-infrared (ATR-IR) spectrum techniques are widely applied to in situ characterization of a gas-solid heterogeneous catalytic reaction, so that the catalyst surface information may be obtained in the condition approximating heterogeneous catalytic reaction. So far, each of the above-mentioned characterization technique uses a commercial infrared spectrometer, and the commercial spectrometer uses single-beam infrared light. If the single-beam infrared spectrometer is used to perform characterization of an in situ catalytic reaction, there is a need to collect background information about a catalyst sample in advance as a background spectrum to eliminate influence of the instrument and sample. However, in the process of a real gas-solid heterogeneous catalytic reaction, the background information about the catalyst may change with the extension of the reaction time. More seriously, a gas molecule vibration spectrum in a real-time state and a transmission spectrum generated in a heating condition may significantly affect test results. Due to the above-mentioned defects thereof, the single-beam infrared spectrum technique cannot obtain surface information about the catalyst in a real reaction state in real time, but only can obtain stationary state and static state information about the catalyst.

To obtain the background information about the catalyst in real time, the patent for invention with the application No. “201110456379.3” obtains a false double-beam light source by adjusting a light source of the infrared spectrum. In the method, a stainless steel in situ infrared sample cell is designed, two ports of the cell body are provided with lids, each lid is provided with an infrared window, a sample bracket is fixed in the cell body, and the sample bracket is provided with two sample tanks, wherein when a sample is tested, one sample tank is unoccupied as a background beam, the other sample tank is used for placing a sample as a sample beam, spectra of two positions are respectively collected, and then a signal adsorbed on the catalyst surface is obtained by subtracting the two spectra from each other. The original intention for designing the in situ infrared cell is good; however, because two sample tanks are set in different positions of the sample bracket, there is a need to adjust the position of the light source of the infrared spectrum in the real process of sample detection to collect spectrograms of the two sample tanks. However, it is difficult to adjust the infrared light source, it is irrealizable to collect the background and sample in real time, and it is difficult to catch the real-time change in the sample surface information. Patent for utility models with the application No. “2013206878256” proposes a method of implementing a double-beam infrared spectrum analyzer, in which a light source is adjusted to obtain two infrared beams which pass through a sample cell and a reference cell respectively, the reference beam passes through an attenuator while the sample beam passes through a chopper, and the two beams are combined into one beam in a light ray concentrator to enter the monochromator. Although the method overcomes the noise interference thereof, there is a need to redesign the light source of the infrared instrument in the real operation process, so that the practicality is poor. So far, it has not been reported that a double-beam infrared spectrometer is used for in situ characterization of a heterogeneous catalytic reaction.

Each commercial infrared spectrum test system comprises a single-beam infrared spectrometer and a single-beam infrared cell, in the process of in situ characterization of the gas-solid heterogeneous catalytic reaction, an infrared spectrum of a catalyst in a static state condition is collected as a background first, and then infrared spectra of gases changing with time in the condition of different temperatures and flow velocities are collected by taking the background as a basis. With the extension of the reaction time, the catalyst surface information is constantly changed, but the background file is not updated in real time so that measurement errors are generated. Moreover, both molecule vibration spectra adsorbing gases and heat radiation generated by heating may disturb final test results. Therefore, a single-beam infrared spectrum system cannot be used for characterization of an in situ heterogeneous catalytic reaction in a real-time state.

### SUMMARY

To solve the above-mentioned problem, the present invention provides a real-time double-beam in situ infrared spectrum system and a method thereof.

The double-beam infrared reaction cell comprises two identical infrared cells (a reference cell and a sample cell) which are in communication with each other and are at the same level, and uses two groups of identical infrared windows to guarantee that the sample beams are identical to the reference beams. The heat distribution and optical path difference of the sample beams are guaranteed to be identical to those of the reference beams through the above-mentioned design.

The present invention has the following technical solution:

A real-time double-beam in situ infrared spectrum system, comprising two identical infrared spectrometers and a double-beam infrared reactor cell,

wherein the two identical infrared spectrometers refer to two infrared spectrometers with identical models, parameters, placing levels and vertical heights, or two infrared spectrometer with different models of which the conditions are identical by debugging; and the two infrared spectrometers are connected to computers respectively, the two computers may automatically collect reference beams and sample beams in real time by controlling the two infrared spectrometers, i.e. the two identical infrared spectrometers are used as a reference infrared spectrometer and a sample infrared spectrometer respectively.

The double-beam infrared reaction cell comprises two identical sample chambers which are in communication with each other and are at the same level, wherein one sample chamber is used as a reference cell, the other sample chamber is used as a sample cell; and uses two groups of identical infrared windows to guarantee that the sample beams are identical to the reference beams; each sample chamber is equipped with a circular sample bracket, and a cell body of the infrared reactor cell is equipped with two pairs of windows which are symmetrical to each other and respectively correspond to the infrared spectrometers collecting the reference beams and the sample beams respectively; circular parts of the two circular sample brackets are wound by two sections of identical heating wires, a thermocouple is inserted in the middle part of the bracket from the top end of the sample bracket to test the real-time temperature of a sample, an inlet and an outlet for condensed water are provided on the periphery of the double-beam infrared reaction cell to control the temperatures of the double-beam infrared reaction cell to be identical, and the sample bracket is connected to the double-beam infrared reaction cell through grinding mouth sealing; and the double-beam infrared reaction cell is connected to a vacuum system through grinding mouth sealing.

Each of the infrared spectrometers is equipped with a mercury cadmium telluride (MCT) detector, an indium stibide (InSb) detector or a DTGS detector with a polythene window, and relevant parameters are adjusted to be consistent.

The cell body of the double-beam infrared reaction cell is made of glass, quartz, polytetrafluoroethylene, stainless steel, aluminum or copper.

A method of using the real-time double-beam in situ infrared spectrum system, comprising the following steps:

while in use, a sample to be tested is prepared into a self-support sheet, the sample sheet is placed on a sample cell bracket of the double-beam infrared reaction cell, and the reference cell is unoccupied; the reference cell is placed on one infrared spectrometer, and the sample cell is placed on the other infrared spectrometer; the double-beam infrared reactor cell is connected to the vacuum system, air, vapor and carbon dioxide in the sample cell are pumped out, the situation of pumping out the gases in the sample cell is detected by a vacuum gauge, and a gas adsorption test is performed according to required conditions; and in the test process, an infrared spectrogram of the reference beams is collected by one infrared spectrometer, and then an infrared spectrogram of the sample beams is collected by the other infrared spectrometer as a final result by taking the infrared spectrogram of the reference beams as a background file. Wherein after the double-beam infrared reactor cell is connected to the vacuum system, cooling water is introduced to control the temperature of the double-beam infrared reactor cell, the temperature of the self-support sheet is increased to 450° C., and the self-support sheet is processed for 4 hours at a system pressure of less than 10⁻³ Pa; and the double-beam infrared reactor cell is disconnected from the vacuum system, an interface between same and the vacuum system is sealed, a reaction gas is introduced into the sample cell at −150 to 500° C., the reacted gas is discharged by the reference cell, a gas adsorption test is performed in the process of introducing the reaction gas, and a test is performed.

Through real test analysis, the constructed double-beam in situ infrared spectrum system can conduct real-time in situ characterization on the gas-solid heterogeneous catalytic reaction in a real reaction condition, to obtain surface phase information in the changing process of the gas phase composition. The double-beam in situ infrared spectrum system has the following advantages of: (1) detecting a two-dimensional spectrogram and a three-dimensional spectrogram in a stationary state of the reaction, and eliminating the interference of a gas molecule vibration spectrum in a real-time state to obtain real information about an adsorbed species on the catalyst surface especially when the gas-solid heterogeneous catalytic reaction is evaluated; (2) collecting spectrograms of sample beams and background beams synchronously in real time through correlation between applications, to obtain information about a species on the catalyst surface changing with the reaction time; (3) synchronously controlling the temperatures of the sample cell and the reference cell to obtain information about different species on the catalyst surface changing with temperature, and eliminating the heat radiation spectrum interference generated in a heating condition, to obtain real-time information about an active center of the catalyst surface, an active phase and an intermediate species at different temperatures; (4) inspecting the change in species on the catalyst surface at different gas partial pressures and flow velocities and thus exploring a reaction mechanism; (5) studying a dimolecular or polymolecular gas-solid reaction mechanism through means such as preadsorption, coadsorption and the like; (6) conducting an isotope labelling experiment research; and (7) conducting the research at different temperatures (−150 to 550° C.).

### DESCRIPTION OF THE DRAWINGS

FIG. 1 is a flowing adsorption spectrogram of isobutene on an HZSM-5 catalyst collected by a single-beam infrared spectrometer (isobutene has a volume concentration of 6%, and nitrogen is used as a balance gas), wherein the adsorption conditions are as follows: the adsorption temperature is 150° C., the gas flow velocity is 3 ml/min, the pressure is atmospheric pressure, and the spectrogram is collected after adsorbing for 30 minutes.

FIG. 2 is a flowing adsorption spectrogram of isobutene on an HZSM-5 catalyst collected by a double-beam infrared spectrometer (isobutene has a volume concentration of 6%, and nitrogen is used as a balance gas), wherein the adsorption conditions are as follows: the adsorption temperature is 150° C., the gas flow velocity is 3 ml/min, the pressure is atmospheric pressure, and the spectrogram is collected after adsorbing for 30 minutes.

FIG. 3 is a time resolution infrared spectrogram of isobutene on an HZSM-5 catalyst collected by a double-beam infrared spectrometer (isobutene has a volume concentration of 6%, and nitrogen is used as a balance gas), wherein the experiment conditions are as follows: the adsorption temperature is 150° C., the gas flow velocity is 3 ml/min, the pressure is atmospheric pressure, and the spectrogram is collected in real time.

FIG. 4 is a time resolution infrared spectrogram of isobutene on an HZSM-5 catalyst collected by a double-beam infrared spectrometer (isobutene has a volume concentration of 6%25, and nitrogen is used as a balance gas), wherein the experiment conditions are as follows: the adsorption temperature is 300° C., the gas flow velocity is 3 ml/min, the pressure is atmospheric pressure, and the spectrogram is collected in real time.

FIG. 5 is an infrared spectrogram of isobutane adsorbed on an HZSM-5 catalyst collected by a double-beam infrared spectrometer (isobutane has a volume concentration of 6%, and nitrogen is used as a balance gas), wherein the experiment conditions are as follows: the adsorption temperature is 150° C., the gas flow velocity is 3 ml/min, the pressure is atmospheric pressure, and the spectrogram is collected in real time.

FIG. 6 is a spectrogram of water and pyridine co-adsorbed on a CeO₂ catalyst, wherein the experiment conditions are as follows: pyridine or water is adsorbed for 30 minutes at 180° C., then is desorbed for 30 minutes in a high vacuum condition, and the spectrogram is collected: (a) pyridine is adsorbed individually; (b) pyridine and water are co-adsorbed for 1 minute; (c) pyridine and water are co-adsorbed for 3 minutes; and (d) pyridine and water are co-adsorbed for 5 minutes.

FIG. 7 is a spectrogram of CO adsorbed on a ZnO/S-1 catalyst at a low temperature (−150° C.), wherein the experiment conditions are as follows: CO is flow adsorbed for 30 minutes at −150° C., then is desorbed for 5 minutes in a high vacuum condition, and the spectrogram is collected.

### DETAILED DESCRIPTION

### Embodiment 1

The test method of the double-beam in situ infrared sample is as follows: a sample is prepared into a self-support sheet, the sample sheet is placed on one sample cell bracket of the double-beam infrared reaction cell, the other sample cell is used as a reference cell, the double-beam infrared sample cell is placed on two infrared spectrometers and is connected to a home-made vacuum system, air, vapor and carbon dioxide in the sample cell are pumped out, the situation of pumping out the gases in the sample cell is detected by a vacuum gauge, a gas adsorption test is performed at a required temperature, and an infrared spectrogram is collected.

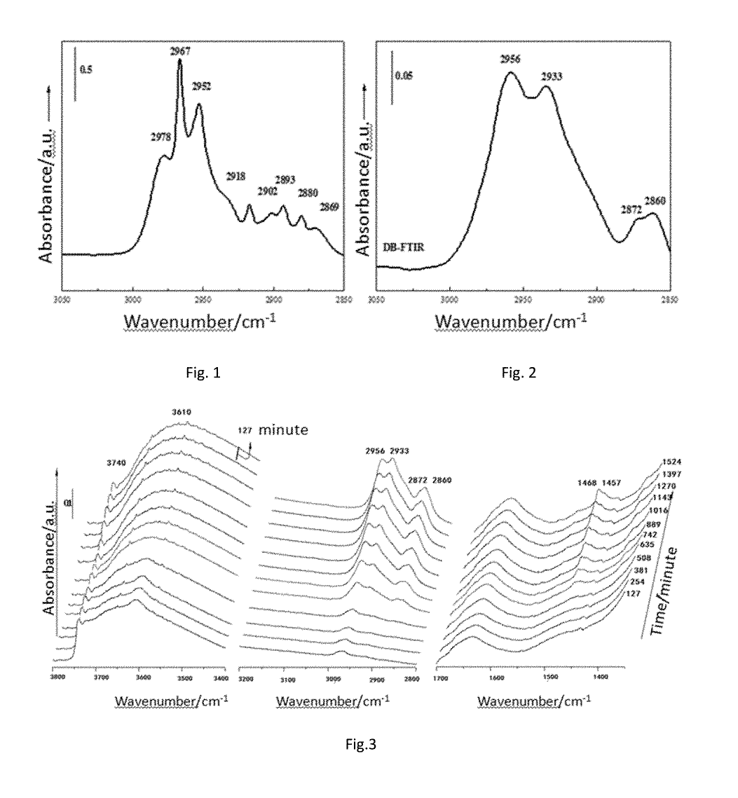

By taking adsorption of isobutene on the HZSM-5 catalyst as an example, the double-beam in situ infrared spectrometer is compared with the single-beam in situ infrared spectrometer. It can be seen from FIG. 1 that after isobutene is flow adsorbed on the single-beam infrared spectrometer, strong absorption peaks may be generated in a stretching vibration area of a C—H bond; these absorption peaks are complicated and are composed of a vibration spectrum of adsorbed isobutene molecules on the catalyst surface and a vibration spectrum of isobutene molecules in a gas-phase state, which is difficult to belong to the vibration spectrum of the adsorbed isobutene molecules. It can be seen from FIG. 2 that the vibration spectrum of the isobutene molecules in the gas-phase state can be well overcome using a double-beam infrared spectrum technique, to obtain an adsorbed isobutene species on the catalyst surface. The above-mentioned result indicates that the real-time vibration spectrum of the gas-phase molecules can be eliminated using the double-beam infrared spectrometer to obtain real information about a sample surface species.

### Embodiment 2

The process of a gas-solid heterogeneous catalytic reaction is characterized in real time in a real reaction condition using the double-beam in situ infrared spectrometer. The interference of the vibration spectrum of gas-phase molecules in a real-time state and heat radiation is eliminated, to obtain situation of change in the species on the catalyst surface at differential reaction time and reaction temperatures. The specific method is as follows: a sample is prepared into a self-support sheet, the sample sheet is placed on one sample cell bracket of the double-beam infrared reaction cell, the other sample cell is used as a reference cell, the double-beam infrared sample cell is placed on two infrared spectrometers and is connected to a home-made vacuum system, air, vapor and carbon dioxide in the sample cell are pumped out at a certain temperature, and the situation of pumping out the gases in the sample cell is detected by a vacuum gauge. Then, a continuous flowing gas absorption test is conducted at an atmospheric pressure and a certain temperature, to collect an infrared spectrogram in real time, wherein the time interval for collecting the spectrogram is 1.27 minutes.

By taking the in situ reaction of isobutene on the HZSM-5 catalyst as an example, flowing isobutene adsorption is conducted on the sample purified in high vacuum at an atmospheric pressure, wherein the reaction temperature is 150° C., the gas flow velocity of isobutene is 3 ml/min, and the change in the species on the catalyst surface in the reaction process is monitored in real time. See FIG. 3 for the result. It can be seen from FIG. 3 that with the extension of the reaction time, characteristic stretching vibration peaks (3610 cm⁻¹) belonging to an acidic active center are gradually weakened, at the same time, the intensity of absorption peaks of a stretching vibration area (2800-3000 cm⁻¹) of the C—H bond is gradually increased, and the intensity of absorption peaks of a variable-angle vibration area (1300-1600 cm⁻¹) of the C—H bond is also significantly increased. After adsorbing for 10 minutes, the amount of the adsorbed isobutene is not changed any longer, indicating that the adsorption reaction achieves a balance. The above-mentioned result indicates that with the extension of the reaction time, an adsorption reaction occurs between isobutene and an acidic active center on the HZSM-5 catalyst.

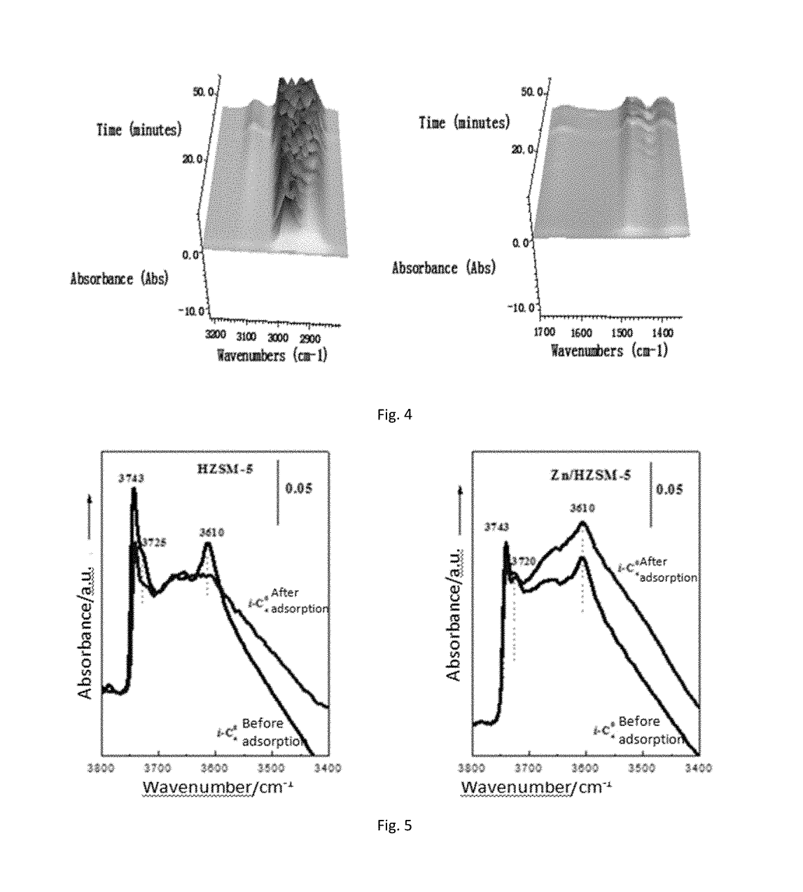

The reaction temperature is increased to 300° C. It can be seen from FIG. 4 that with the extension of the reaction time, characteristic stretching vibration peaks (3000-3100 cm⁻¹) belonging to the aromatic hydrocarbon are gradually enhanced, at the same time, the intensity and number of the absorption peaks of the stretching vibration area (2800-3000 cm⁻¹) of the C—H bond are synchronously increased, and the intensity of the absorption peaks of the variable-angle vibration area (1300-1600 cm⁻¹) of the C—H bond is also significantly increased. With the extension of the reaction time, an aromatization reaction occurs between isobutene and the acidic active center on the HZSM-5 catalyst. The above-mentioned experiment result indicates that the adsorption process and aromatization reaction course of isobutene on the acidic active center of the HZSM-5 catalyst are monitored using the double-beam in situ infrared spectrometer in real time at different temperatures.

### Embodiment 3

The test method of the double-beam in situ infrared sample is as follows: a sample is prepared into a self-support sheet, the sample sheet is placed on one sample cell bracket of the double-beam infrared reaction cell, the other sample cell is used as a reference cell, the double-beam infrared sample cell is placed on two infrared spectrometers and is connected to a home-made vacuum system, air, vapor and carbon dioxide in the sample cell are pumped out at a certain temperature, the situation of pumping out the gases in the sample cell is detected by a vacuum gauge, a gas adsorption test is performed at a required temperature, and an infrared spectrogram is collected.

By taking adsorption of isobutane on HZSM-5 and Zn/HZSM-5 catalysts as an example, the change in the active center of the catalyst in situ characterized by the double-beam in situ infrared spectrometer is inspected. It can be seen from FIG. 5 that after isobutane is adsorbed on the HZSM-5 catalyst, the intensity of the 3610 cm⁻¹ absorption peaks belonging to a strong acid center of a framework aluminum hydroxyl group (Si(OH)Al) with Brønsted acid properties is significantly weakened; while on the Zn/HZSM-5 catalyst, such a absorption peak intensity is somewhat increased, which is due to the fact that isobutane is desorbed on the Zn/HZSM-5 catalyst, so that a part of the framework aluminum hydroxyl group is restored. The above-mentioned result indicates that the double-beam in situ infrared spectrometer may quantitatively characterize the change in the active center of the catalyst surface in a real reaction state.

### Embodiment 4

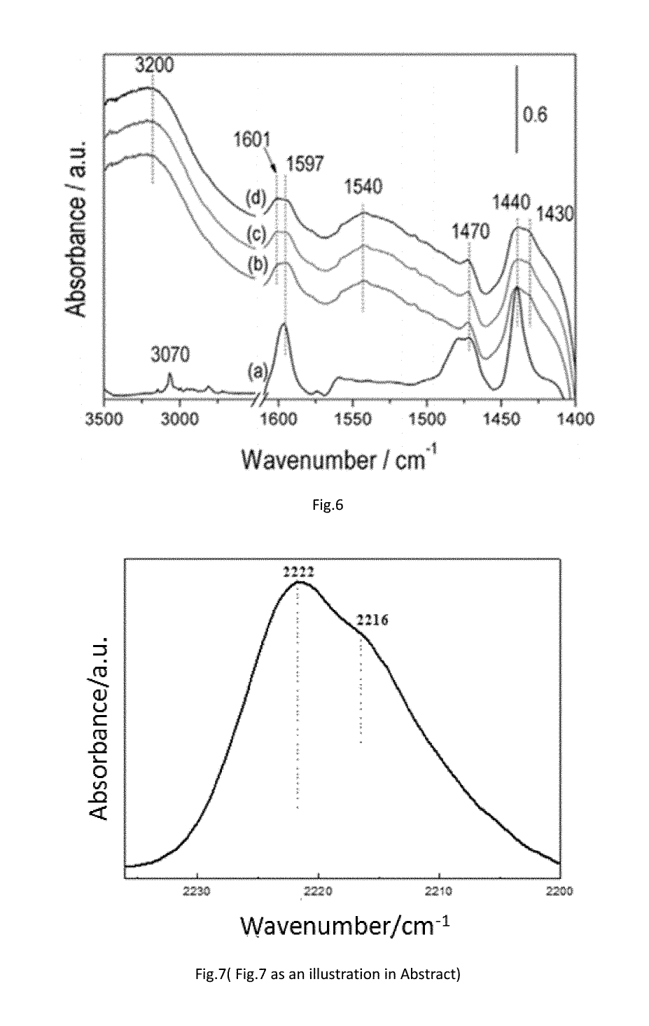

The double-beam in situ infrared spectrometer may complete a double-probe molecule adsorption experiment. Pyridine adsorption is an important means for characterizing a Brønsted acid center and a Lewis acid center of the solid catalyst surface. Pyridine and water molecule coadsorption may characterize the changing process of the active center of the catalyst surface in the water-containing reaction process. As shown in FIG. 6, after pyridine is adsorbed on the CeO₂ surface, the Lewis acid center located at the 1440 cm⁻¹ wave number occurs, after water molecules are adsorbed, and the Brønsted acid center located at the 1540 cm⁻¹ wave number occurs, to successfully characterize the changing process of the active center of the CeO₂ catalyst surface in a reaction condition.

### Embodiment 5

The double-beam in situ infrared sample cell may be used within the temperature range of −150 to 550° C., and may be used for studying active centers and reaction mechanisms of different catalysts. CO low-temperature infrared adsorption is an important means for characterizing active centers of metal oxide. As shown in FIG. 7, at a liquid nitrogen temperature (−150° C.), after CO is adsorbed on the ZnO/S-1 catalyst, characteristic absorption peaks located at 2222 and 2216 cm⁻¹ wave numbers occur, which respectively correspond to sub-nanometer ZnO cluster and Zn²⁺ active center located in a duct of a molecular sieve.

1. A real-time double-beam in situ infrared spectrum system, comprising two identical infrared spectrometers and a double-beam infrared reactor cell,
wherein the two identical infrared spectrometers refer to two infrared spectrometers with identical models, parameters, placing levels and vertical heights, or two infrared spectrometer with different models of which the conditions are identical by debugging; and the two infrared spectrometers are connected to computers respectively, and the two computers may automatically collect spectra of the reference beams and sample beams in real time by controlling the two infrared spectrometers, i.e. the two identical infrared spectrometers are used as a reference infrared spectrometer and a sample infrared spectrometer respectively;
the double-beam infrared reactor cell comprises two identical sample chambers which are in connection with each other and are at the same level, wherein one sample chamber is used as a reference cell, and the other sample chamber is used as a sample cell; and uses two groups of identical infrared windows to guarantee that the sample beams are identical to the reference beams; each sample chamber is equipped with a circular sample bracket, and a cell body of the infrared reactor cell is equipped with two pairs of windows which are symmetrical to each other and respectively correspond to the infrared spectrometers collecting the reference beams and the sample beams respectively; and circular parts of the two circular sample brackets are wound by two sections of identical heating wires, a thermocouple is inserted in the middle part of the bracket from the top end of the sample bracket to test the real-time temperature of a sample, an inlet and an outlet for condensed water are provided on the periphery of the double-beam infrared reactor cell to control the temperatures of the double-beam infrared reactor cell to be identical, and the sample bracket is connected to the double-beam infrared reactor cell through grinding mouth sealing.

2. The real-time double-beam in situ infrared spectrum system according to claim 1, wherein each of the infrared spectrometers is equipped with a mercury cadmium telluride (MCT) detector, an indium stibide (InSb) detector or a DTGS detector with a polythene window, and relevant parameters are adjusted to be consistent.

3. The real-time double-beam in situ infrared spectrum system according to claim 1, wherein the cell body of the double-beam infrared reactor cell is made of glass, quartz, polytetrafluoroethylene, stainless steel, aluminum or copper.

4. The real-time double-beam in situ infrared spectrum system according to claim 1, wherein the double-beam infrared reactor cell is connected to a vacuum system through grinding mouth sealing.

5. The real-time double-beam in situ infrared spectrum system according to claim 3, wherein the double-beam infrared reactor cell is connected to a vacuum system through grinding mouth sealing.

6. The real-time double-beam in situ infrared spectrum system according to claim 1, wherein:
a sample to be tested is prepared into a self-support sheet, the sample sheet is placed on a sample cell bracket of the double-beam infrared reactor cell, and the reference cell is unoccupied;
the reference cell is placed on one infrared spectrometer, and the sample cell is placed on the other infrared spectrometer;
the double-beam infrared reactor cell is connected to the vacuum system, air, vapor and carbon dioxide in the sample cell are pumped out, the situation of pumping out the gases in the sample cell is detected by a vacuum gauge, and a gas adsorption test is performed according to required conditions; and in the test process, an infrared spectrogram of the reference beams is collected by one infrared spectrometer, and then an infrared spectrogram of the sample beams is collected by the other infrared spectrometer as a final result by taking the infrared spectrogram of the reference beams as a background file.

7. A method for measuring an infrared spectrum using the real-time double-beam in situ infrared spectrum system according to claim 6, wherein: after the double-beam infrared reaction cell is connected to the vacuum system, cooling water is introduced to control the temperature of the double-beam infrared reactor cell, the temperature of the self-support sheet is increased to 450° C., and the self-support sheet is processed for 4 hours at a system pressure of less than 10⁻³ Pa; and the double-beam infrared reactor cell is disconnected from the vacuum system, an interface between same and the vacuum system is sealed, a reaction gas is introduced into the sample cell at −150 to 500° C., the reacted gas is discharged by the reference cell, a gas adsorption test is performed in the process of introducing the reaction gas, and a test is performed.
